(19) United States
(12) Patent Application Publication
(10) Pub. No.: US 2005/0228740 A1
(43) Pub. Date: Oct. 13, 2005

(54) Machine purchasing system and method

(76) Inventors: Kuo-Chin Chang, Tu-Chen (TW); Wu Ma, Shenzhen (CN); Junma Zheng, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/822,179

(22) Filed: Apr. 9, 2004

(30) Foreign Application Priority Data
Apr. 9, 2004 (TW) 92108171

(51) Int. Cl. G06F 17/60

(52) U.S. Cl. 705/37

(57) ABSTRACT

A machine purchasing system includes a database server (1), an application server (2), and a plurality of distributed client computers (4). The system receives historical transaction records from a financial management system (6) and current prices from an electronic marketing system (5), and sets a base price for each to-be-purchased machine based on the above received information. Users select one or more eligible suppliers based on the base price and the supplier's information. The client computers are for searching information stored in the database server. A related machine purchasing method is also disclosed.

### BACKGROUND OF THE INVENTION

1. Field of the Invention

This invention is related to systems and methods for purchasing machines on the Internet, and especially to systems and methods for purchasing machines through public bidding and bargaining on the Internet.

2. Description of Prior Art

Traditional commercial purchasing may be simplified down to three basic steps: collecting suppliers' information, selecting eligible suppliers, and bargaining with the eligible suppliers to select a successful supplier. Traditional purchasing procedures are rather time-consuming, and purchasing organizations cannot necessarily procure products or services on the most favorable terms. With the development of Internet technology, bidding for purchase contracts is now frequently performed through the World Wide Web. Taiwan Patent TW486655 issued on May 11, 2002 and entitled Electronic Trading Mechanism For Competing Bidding And Bargaining On Internet Machines discloses a collective bidding method. The method comprises: the suppliers first putting their products on the shelf, then determining the prices for the products according to various quantity ranges, and then inviting Internet consumers to collectively bargain by using the quantity range pricing method; different suppliers lowering the prices for various quantity ranges; and finally the company that placed the lowest bid price for the machine winning the bid, and all Internet consumers who participated in the bargaining obtaining the products at the lowest bid price.

However, this patent does not provide any function of taking into account historical transaction records held by the purchasing organization, the transaction records including standard of performance of suppliers and historical transaction prices.

### SUMMARY OF THE INVENTION

A primary object of the present invention is to provide a machine purchasing system and method which takes into account historical transaction records of a purchasing organization.

Another object of the present invention is to provide a machine purchasing system and method which facilitates compiling of purchasing schemes and drawing up of legal contracts.

To achieve the above objects, in one aspect of the present invention, a machine purchasing system comprises: a database server for storing information on purchased machines; an application server for receiving current prices of to-be-purchased machines and information on suppliers from an electronic marketing system, receiving historical transaction records from a financial management system, setting base prices for bidding, and electing one or more appropriate suppliers; and a plurality of distribute client computers for searching information stored in the database server and storing information in the database server.

In another aspect of the present invention, a machines purchasing method comprises the steps of: setting basic information on to-be-purchased machines; receiving historical transaction records from a financial management system; receiving current prices of the to-be-purchased machines; setting a base price for each to-be-purchased machine based on the historical transaction records and the current prices; compiling a purchasing scheme based on the base price; opening bidding documents to suppliers; receiving suppliers' responses to the bidding documents; determining whether a quotation of any supplier exceeds the base price; excluding a supplier if the quotation of the supplier exceeds the base price; auditing information on a supplier in order to determine whether the supplier is eligible if the quotation of the supplier does not exceed the base price; and selecting one or more successful suppliers from all eligible suppliers.

Other objects, advantages and novel features of the present invention will be drawn from the following detailed description of preferred embodiments of the present invention with the attached drawings, in which:

### BRIEF DESCRIPTION OF THE DRAWINGS

FIG. 1 shows system architecture of a machine purchasing system in accordance with a preferred embodiment of the present invention;

FIG. 2 is a schematic diagram of function modules of an application server of the system of FIG. 1; and

FIG. 3 is a flow chart of preferred operation of the machine purchasing system.

### DETAILED DESCRIPTION OF THE PREFERRED EMBODIMENT

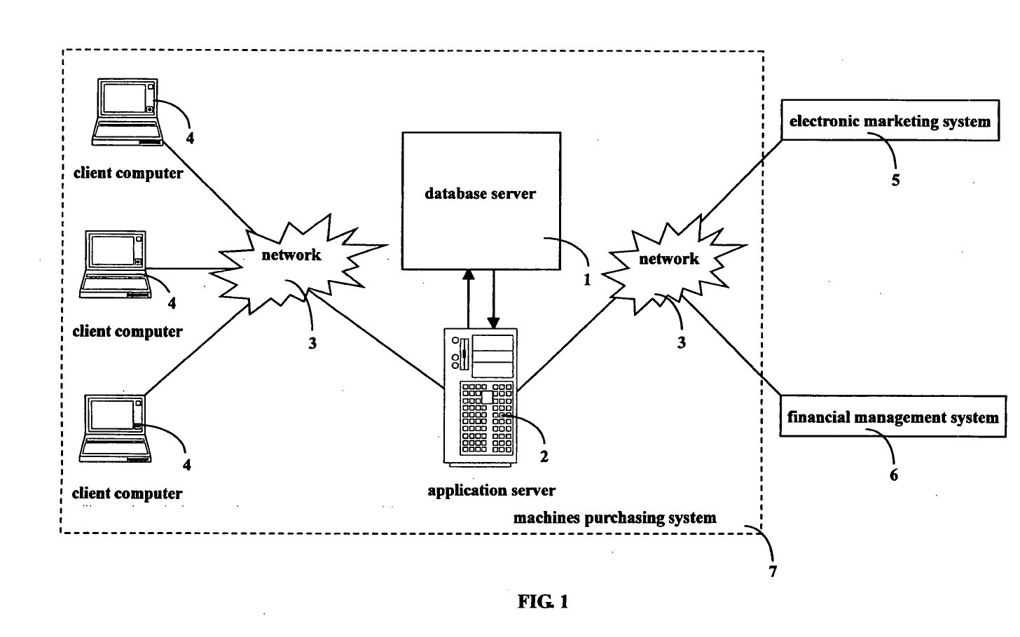

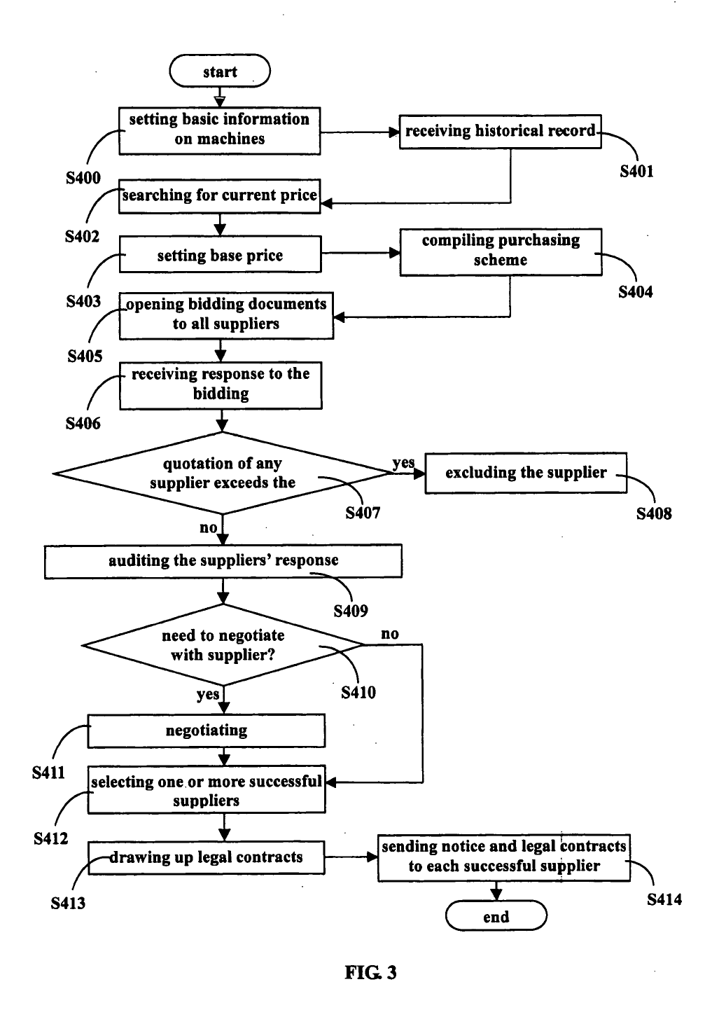

FIG. 1 shows system architecture of a machine purchasing system 7 in accordance with the preferred embodiment of the present invention. The machine purchasing system 7 comprises a database server 1, an application server 2, a plurality of client computers 4, and a network 3 interconnecting all the above devices. The database server 1 is used for storing information on purchasing machines. The application server 2 is provided for setting base prices of to-be-purchased machines and for compiling purchasing schemes. This is described in more detail below with reference to FIG. 3. The client computers 4 are located in various different places of an organization that implements the machine purchasing system 7, and are for reading information stored in the database server 1 and storing information in the database server 1.

The machine purchasing system 7 is connected with an electronic marketing system 5 and a financial management system 6 via the network 3. The electronic marketing system 5 provides an operating platform through which various purchasing organizations can initiate public bidding activities. The electronic marketing system 5 collects basic information on bidding companies and their respective quotations. The financial management system 6 is responsible for setting base prices for purchasing projects, and providing a reasonable price range for each purchasing project when there is a need to negotiate prices with bidders.

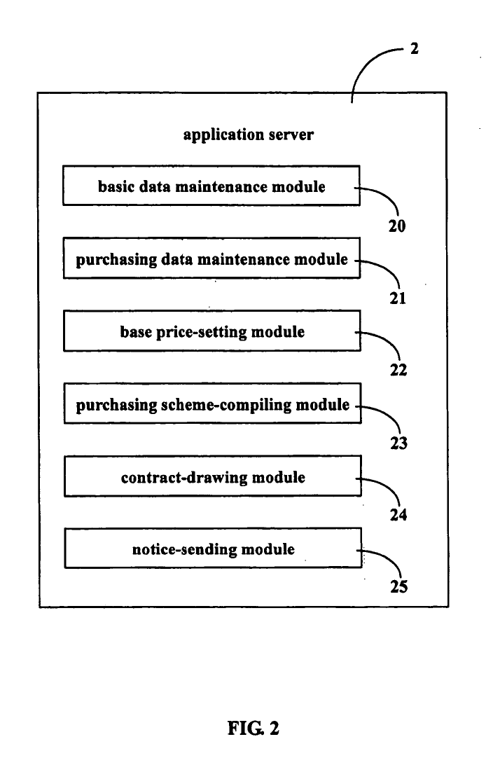

FIG. 2 is a schematic diagram of function modules of the application server 2. The application server 2 comprises a basic data maintenance module 20, a purchasing data maintenance module 21, a base price-setting module 22, a purchasing scheme-compiling module 23, a contract-drawing module 24, and a notice-sending module 25.

The basic data maintenance module 20 is provided for recording basic information on machines including names of machines and types of machines. The purchasing data maintenance module 21 is used for recording and updating information on machine purchasing, and storing said information in the database server 1. The information on machine purchasing includes current prices of machines and information on suppliers. The base price-setting module 22 is for setting a base price for each machine based on historical prices, price ranges, and the current prices of comparable machines. The purchasing scheme-setting module 23 provides different purchasing scheme templates, and is used for compiling purchasing schemes stored in the database server 1. The contract-drawing module 24 provides different legal contract templates, and is used for drawing up legal contracts for machine purchases. The notice-sending module 25 is for sending notices recording bidding results and legal contracts on machine purchasing to each successful supplier.

FIG. 3 is a flow chart of preferred operation of the machine purchasing system 7. Firstly, in step S400, users set basic information on to-be-purchased machines through any of the client computers 4. In step S401, the machine purchasing system 7 receives historical records of purchases of the same or similar machines from the financial management system 6. The historical records include standard of performance of suppliers, historical prices, and prices ranges of the machines. In step S402, the purchasing data maintenance module 21 searches the electronic marketing system 5 for current prices of the to-be-purchased machines. In step S403, the base price-setting module 22 sets a base price for purchasing the machines, based on the historical records and the current prices. In step S404, the users compile a purchasing scheme through the purchasing scheme-compiling module 23, based on the basic information on the machines and the base price of the machines. The compiled purchasing scheme is stored in the database server 1, and is then available for searching, editing and deleting through appropriate operations on any of the client computers 4. In step S405, the machine purchasing system 7 transmits the compiled purchasing scheme to the electronic marketing system 5. The electronic system 5 receives the purchasing scheme, generates formatted bidding documents, and opens the bidding documents to all suppliers in the marketplace. In step S406, the electronic marketing system 7 receives responses of suppliers to the bidding documents, the responses including information on the suppliers and quotations of the suppliers. In step S407, the electronic marketing system 7 determines whether the quotation of any supplier exceeds the base price. If the quotation of any supplier exceeds the base price, in step S408, each such supplier is excluded. If the quotation of any supplier does not exceed the base price, in step S409, the users audit each such supplier's response. In particular, the users audit the information on the supplier and the standard of performance of the supplier to determine whether the supplier is eligible. In step S410, the users determine whether it is necessary to negotiate with any of the eligible suppliers. If it is necessary to negotiate with a supplier, in step S411, the users negotiate with the supplier via mail, telephone or other suitable communication means. In step S412, the users finally select one or more successful suppliers. In step S413, the users draw up one or more legal contracts through the contract-drawing module 24. Finally, in step S414, the notice-sending module 25 sends a notice to each successful supplier to inform it of its success. The notice-sending module 25 also sends the legal contracts to the successful suppliers, and requests the successful suppliers to sign the legal contracts.

The embodiment and method described herein are merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

1. A machine purchasing system, comprising:
a database server for storing information on purchased machines;
an application server for receiving current prices of to-be-purchased machines and information on suppliers from an electronic marketing system, receiving historical transaction records from a financial management system, setting base prices for bidding, and electing one or more appropriate suppliers;
a plurality of distribute client computers for searching information stored in the database server and storing information in the database server.

2. The machine purchasing system as claimed in claim 1, wherein the application server comprises a basic data maintenance module for setting basic information on to-be-purchased machines.

3. The machine purchasing system as claimed in claim 1, wherein the application server comprises a purchasing data maintenance module for recording and updating information on machine purchasing.

4. The machine purchasing system as claimed in claim 1, wherein the application server comprises a base price-setting module for setting a base price of each to-be-purchased machine based on the current price of the machine and historical transaction records.

5. The machine purchasing system as claimed in claim 1, wherein the application server comprises a purchasing scheme-compiling module for compiling purchasing schemes.

6. The machine purchasing system as claimed in claim 1, wherein the application server comprises a contract-drawing module for drawing up legal contracts on purchasing machines.

7. The machine purchasing system as claimed in claim 1, wherein the application server comprises a notice-sending module for sending notices on bidding results to corresponding suppliers.

8. A machine purchasing method, comprising the steps of:
setting basic information on to-be-purchased machines;
receiving historical transaction records from a financial management system;
receiving current prices of the to-be-purchased machines;
setting a base price for each to-be-purchased machine based on the historical transaction records and the current prices;
compiling a purchasing scheme based on the base price;
opening bidding documents to suppliers;
receiving suppliers' responses to the bidding documents;
determining whether a quotation of any supplier exceeds the base price;
excluding a supplier if the quotation of the supplier exceeds the base price;
auditing information on a supplier in order to determine whether the supplier is eligible if the quotation of the supplier does not exceed the base price; and
selecting one or more successful suppliers from all eligible suppliers.

9. The machine purchasing method as claimed in claim 8, further comprising the steps of:
determining whether it is necessary to negotiate with any eligible supplier; and
negotiating with an eligible supplier if it is necessary to negotiate with the eligible supplier.

10. The machine purchasing method as claimed in claim 8, further comprising the step of sending a notice to each successful supplier to inform the supplier of success.

11. The machine purchasing method as claimed in claim 8, further comprising the step of drawing up one or more legal contracts.

12. The machine purchasing method as claimed in claim 11, further comprising the step of sending said legal contracts to said successful suppliers and requesting said successful suppliers to sign said legal contracts.
